(19) United States
(12) Patent Application Publication
(10) Pub. No.: US 2016/0284465 A1
(43) Pub. Date: Sep. 29, 2016

(54) Electromagnetic Interference Shield for Wireless Power Transfer

(71) Applicant: Sanjaya Maniktala, Fremont, CA (US)

(72) Inventor: Sanjaya Maniktala, Fremont, CA (US)

(21) Appl. No.: 15/082,739

(22) Filed: Mar. 28, 2016

Related U.S. Application Data
(60) Provisional application No. 62/139,785, filed on Mar. 29, 2015.
(60) Provisional application No. 62/144,594, filed on Apr. 8, 2015.

(51) Int. Cl. H01F 27/36; H02J 50/12; H01F 38/14

(52) U.S. Cl. CPC H01F 27/362; H01F 38/14; H01F 27/365; H02J 50/12

(57) ABSTRACT

In one embodiment, a wireless power transmitter includes an alternating current source, a transmitter coil configured to receive an alternating current from the alternating current source, and a shield coil located substantially directly above the transmitter coil, one end of the shield coil being coupled to ground. The shield coil acts as an EMI shield to ground high-frequency noise generated by the transmitter coil. The wireless power transmitter may also include a capacitor coupled between a second end of the shield coil and ground. In another embodiment, a wireless power transmitter includes a plurality of transmitter coils and a plurality of shield coils, each of the plurality of shield coils located substantially directly above one of the plurality of transmitter coils, the plurality of shield coils being coupled together in series between ground and a first end of a capacitor, the capacitor having a second end coupled to ground.

### CROSS-REFERENCE TO RELATED APPLICATION

This application claims the benefit of and incorporates by reference in their entirety U.S. Provisional Patent Application No. 62/144,594, entitled “Electromagnetic Interference Shield,” filed on Apr. 8, 2015 and U.S. Provisional Patent Application No. 62/139,785, entitled “Wireless Power Transfer Method Using Multiple Coil Arrays,” filed on Mar. 29, 2015.

### FIELD OF THE INVENTION

The invention relates generally to wireless power transfer and more particularly to an electromagnetic interference shield for wireless power transfer.

### BACKGROUND

Electronic devices typically require a connected (wired) power source to operate, for example, battery power or a wired connection to a direct current (“DC”) or alternating current (“AC”) power source. Similarly, rechargeable battery-powered electronic devices are typically charged using a wired power-supply that connects the electronic device to a DC or AC power source. The limitation of these devices is the need to directly connect the device to a power source using wires.

Wireless power transfer (WPT) systems typically use time-varying magnetic fields and the principle of magnetic induction or magnetic resonant induction to transfer power wirelessly. In accordance with Faraday's Law, a time-varying current applied to a transmitter coil produces a magnetic field that will induce a voltage in a receiver coil that is in close proximity to the transmitter coil. The induced voltage in the receiver coil is typically rectified and filtered to produce a substantially direct current (DC) voltage that can provide power to an electronic device or a rechargeable battery. Such wireless power transfer systems may use magnetic induction or magnetic resonant induction techniques, both of which emit magnetic flux in the “near-field.” Such near-field techniques are capable of transferring power only when the transmitter coil and the receiver coil are within a short distance from one another, typically on the order of a few centimeters or less.

The Wireless Power Consortium (WPC) was established in 2008 to develop the Qi inductive power standard for charging and powering electronic devices. Powermat is another well-known standard for WPT developed by the Power Matters Alliance (PMA). The Qi and Powermat near-field standards operate in the frequency band of 100-400 kHz. The problem with near-field WPT technology is that typically only 5 Watts of power can be transferred over the short distance of 2 to 5 millimeters between a power source and an electronic device, though there are ongoing efforts to increase the power. For example, some concurrently developing standards achieve this by operating at much higher frequencies, such as 6.78 MHz or 13.56 MHz. Though they are called magnetic resonance methods instead of magnetic induction, they are based on the same underlying physics of magnetic induction. There also have been some market consolidation efforts to unite into larger organizations, such as the AirFuel Alliance consisting of PMA and the Rezence standard from the Alliance For Wireless Power (A4WP), but the technical aspects have remained largely unchanged.

FIG. 1 is a diagram of a prior art embodiment of a single coil structure for wireless power transfer. A transmitter 100 includes a DC voltage source 110, a half-bridge inverter circuit 112, a resonant capacitor 114, and a coil 116. Coil 116 is typically a flat spiral coil with a predetermined number of turns. Half-bridge inverter circuit 112 is controlled by a control circuit (not shown) to provide an alternating current to capacitor 114 and coil 116. The frequency of the current is typically in the range of 100 KHz to 400 kHz. The capacitance value of capacitor 114 and the inductance value of coil 116 determine a resonant frequency for transmitter 100. The alternating current passing through coil 116 generates magnetic flux that can induce a current in a receiver coil (not shown).

Electromagnetic Interference (EMI) is generated by nearly all electronic devices at varying levels. EMI leaks can occur at almost any point in a circuit design if not properly shielded. In the United States, the Federal Communications Commission (FCC) has authority over radiated signals within certain operating frequencies. For example, the FCC's Part 15 regulations set strict limits on the amount of allowable EMI from electronic products, such as computers and smartphones. The International Electrotechnical Commission (IEC) sets global standards for accepted levels of radiated EMI. Such agencies require testing of devices that may be sources of EM radiation to ensure that the standards are met.

In transformers, primary-winding voltage transients produce EMI that can be transmitted to the secondary winding. A Faraday shield is one type of structure that is commonly placed between a transformer's primary and secondary windings to reduce EMI. It typically consists of one sheet of thin copper foil between the primary and secondary windings that is attached to the circuit grounds on either side of the transformer or to the system ground plane. This shield prevents high-frequency current from coupling from the primary to the secondary windings. Coupling of these unwanted currents normally occurs as a result of interwinding capacitance. But such shields are expensive and reduce overall efficiency of the transformer by 1%-3% due to eddy currents produced in the foil. Another technique used in transformers is to add a thin low-current winding between the primary winding and the insulating interface to the secondary winding.

Coils in wireless power transmitters can be severe sources of EMI because of the exposed area of the transmitter coils. In addition to the intended magnetic flux produced by a transmitter coil, high-frequency current in the transmitter coil caused by voltage spikes can also be transmitted to a receiver coil, and perhaps worse, to the environment in the form of electromagnetic radiation that can cause neighboring devices such a radio receiver to operate poorly. Thus there is a need for EMI shielding in wireless power transfer devices.

### SUMMARY

In one embodiment, a wireless power transmitter includes an alternating current source, a transmitter coil configured to receive an alternating current from the alternating current source, and a shield coil located substantially directly above the transmitter coil, one end of the shield coil being coupled to ground. The shield coil acts as an EMI shield to divert to ground the noise generated by the transmitter coil. The wireless power transmitter also includes a small capacitor coupled between a second end of the shield coil and ground to provide a path to ground, but only for the high-frequency noise generated by the voltage transients responsible for EMI while not interfering with the low frequency magnetic field responsive for the intended wireless transmission of power to the receiver. In this embodiment, the shield coil has a shape, number of turns, and an area that are substantially the same as a shape, a number of turns, and an area of the transmitter coil.

In another embodiment, a wireless power transmitter includes an alternating current source, a plurality of transmitter coils configured to receive an alternating current from the alternating current source, the plurality of transmitter coils coupled together in series, and a plurality of shield coils, each of the plurality of shield coils located substantially directly above one of the plurality of transmitter coils, the plurality of shield coils being coupled together in series between ground and a first end of a capacitor, the capacitor having a second end coupled to ground. The plurality of shield coils act as EMI shields to ground noise generated by the plurality of transmitter coils.

### BRIEF DESCRIPTION OF THE DRAWINGS

FIG. 1 is a diagram of a prior art embodiment of wireless power transmitter;

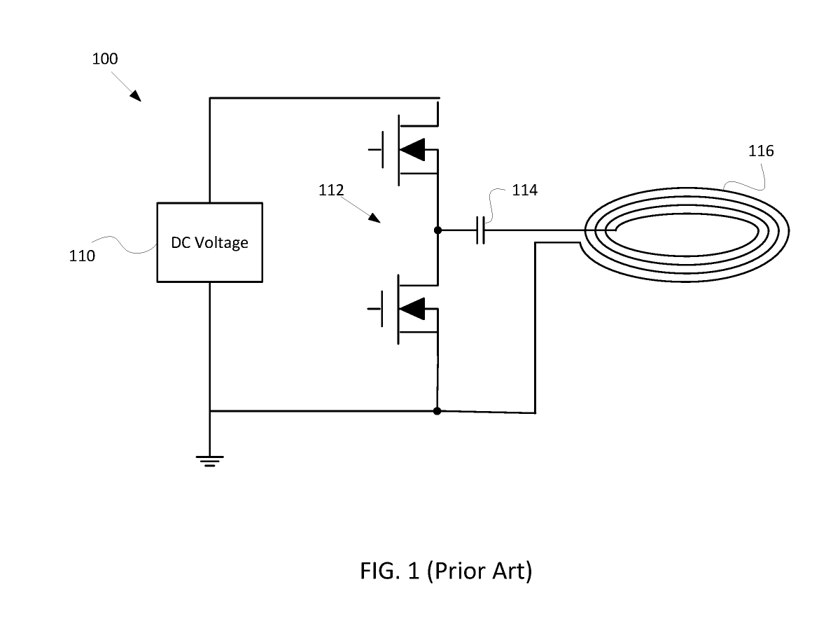

FIG. 2 is a diagram of one embodiment of a wireless power transmitter with an electromagnetic interference shield, according to the invention;

FIG. 3 is a diagram of one embodiment of a wireless power transmitter with an electromagnetic interference shield, according to the invention;

FIG. 4 is a diagram of one embodiment of a wireless power transmitter with multiple electromagnetic interference shields, according to the invention; and

FIG. 5 is a diagram of one embodiment of a wireless power transmitter with an electromagnetic interference shield, according to the invention.

### DETAILED DESCRIPTION

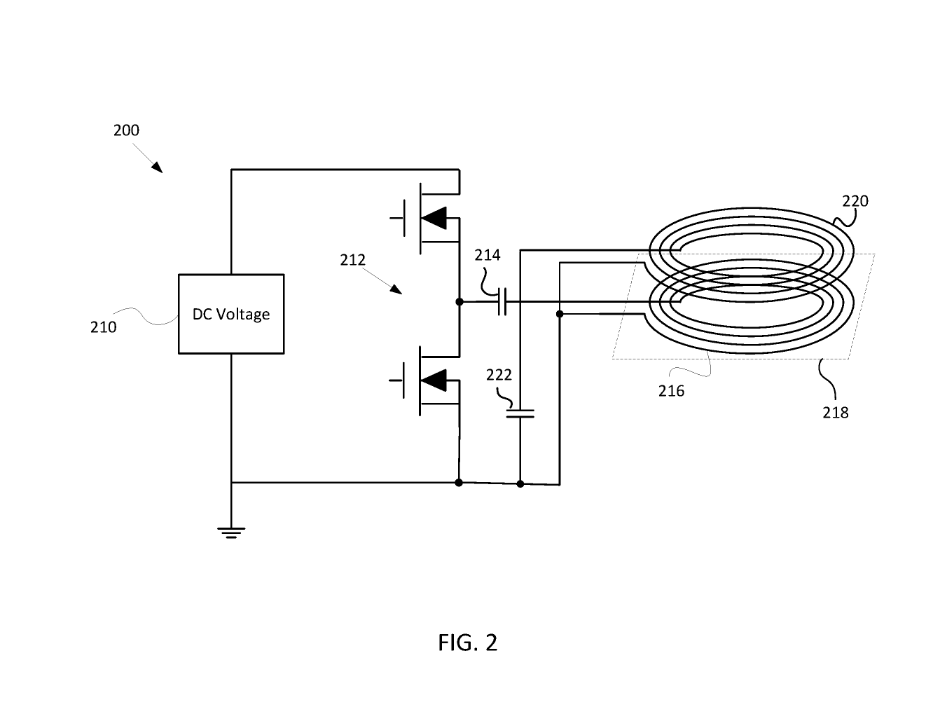

FIG. 2 is a diagram of one embodiment of a wireless power transmitter with an electromagnetic interference shield, according to the invention. A transmitter 200 includes, but is not limited to, a DC voltage source 210, a half-bridge inverter circuit 212, a resonant capacitor 214, and a transmitter coil 216. Transmitter coil 216 is a flat spiral coil with a predetermined number of turns; however, coils of any shape with any number of turns are within the scope of the invention. Transmitter coil 216 can be formed of wire or traces on a printed circuit board using conductive material such as copper, gold, or any other conductive material known in the art. Half-bridge inverter circuit 212 is controlled by a control circuit (not shown) to provide an alternating current to capacitor 214 and transmitter coil 216. The generated AC signal can be, but is not limited to, a square wave, a sinusoidal wave, a triangular wave, or a sawtooth wave. Although DC voltage source 210 and half-bridge inverter circuit 212 are shown in FIG. 2, any circuit configured to generate an AC signal is within the scope of the invention. The capacitance value of capacitor 214 and the inductance value of transmitter coil 216 determine a resonant frequency for transmitter 200, which is preferably in the range of 100 kHz to 250 kHz. The alternating current passing through coil 216 generates magnetic flux that can induce a current in a receiver coil (not shown). An optional magnetic layer 218 beneath transmitter coil 216 enhances magnetic coupling between transmitter coil 216 and a receiver coil. Magnetic layer 218 can be made of ferrite or any other magnetic material known in the art.

Transmitter 200 further includes a shield coil 220 that operates as an electromagnetic shield by virtue of its high-frequency connection to ground. Shield coil 220 preferably has substantially the same shape, number of turns, and area as transmitter coil 216, and can also be formed of wire or traces on a printed circuit board using conductive material such as copper, gold, or any other conductive material known in the art. But the thickness of shield coil 220 can be much less than that of transmitter coil 216 because shield coil 220 only carries very small high-frequency currents associated with EMI. Shield coil 220 is preferably placed directly above and flush with transmitter coil 216, but may be a short distance, on the order of a couple millimeters, from transmitter coil 216. A receiver coil (not shown) may or may not be present, but if present is intended to be placed above, but not in direct contact with, shield coil 220. One end 232 of shield coil 220 is coupled to ground, and the other end 234 is coupled to a capacitor 222. Capacitor 222 is coupled between shield coil 220 and ground, and preferably has a small capacitance value less than about 1000 pF to allow only high-frequency current to be diverted to ground by shield coil 220 while not interfering with the intended wireless transmission of power by transmitter coil 216. In another embodiment, end 234 of shield coil 220 is not connected, i.e., left floating. In another embodiment, the total capacitance value of less than about 1000 pF can be divided between two capacitors, one capacitor coupled between end 232 of shield coil 220 and ground and the second capacitor coupled between end 234 of shield coil 220 and ground. Shield coil 220 will receive and divert to ground any high-frequency EMI generated by transmitter coil 216. Because shield coil 220 and transmitter coil 216 are substantially the same shape, EMI emitted by a turn of transmitter coil 216 will be received by a turn of shield coil 220 through intervening capacitance. Current flowing through shield coil 220 caused by received EMI will produce magnetic flux but only in response to high frequency components of the current. The magnetic flux generated by shield coil 220 will be at a much higher frequency than the flux generated by transmitter coil 216 and thus will not noticeably affect the transmission of power from transmitter 200 to a receiver.

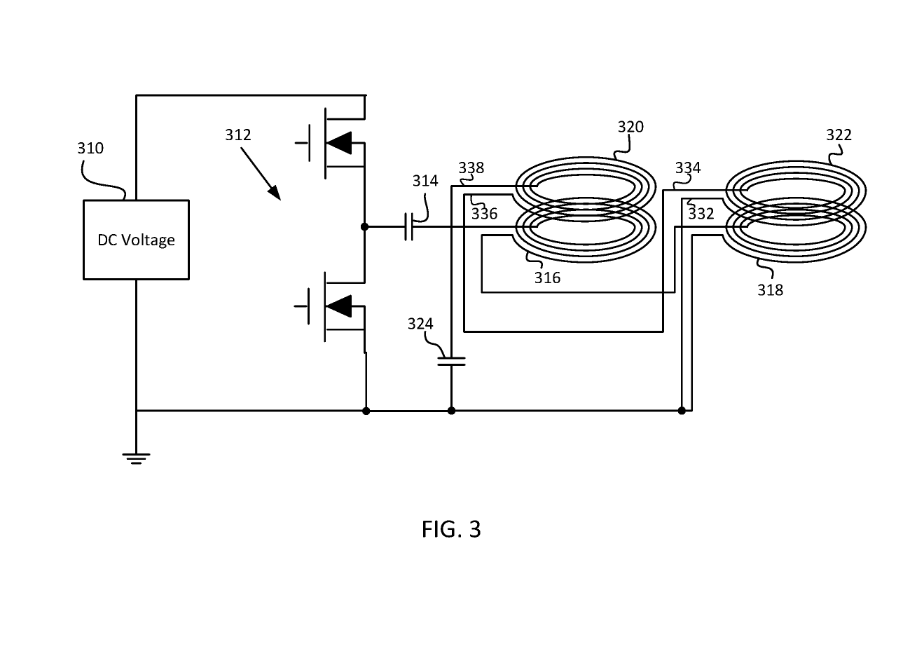

FIG. 3 is a diagram of one embodiment of a wireless power transmitter with an electromagnetic interference shield, according to the invention. A transmitter 300 includes, but is not limited to, a DC voltage source 310, a half-bridge inverter circuit 312, a resonant capacitor 314, and transmitter coils 316 and 318. Transmitter coils 316 and 318 are coupled to each other in series. Each of transmitter coil 316 and transmitter coil 318 is a flat spiral coil with a predetermined number of turns; however, coils of any shape with any number of turns are within the scope of the invention. Transmitter coils 316 and 318 can be formed of wire or traces on a printed circuit board using conductive material such as copper, gold, or any other conductive material known in the art. Half-bridge inverter circuit 312 is controlled by a control circuit (not shown) to provide an alternating current to capacitor 314 and transmitter coils 316 and 318. The generated AC signal can be, but is not limited to, a square wave, a sinusoidal wave, a triangular wave, or a sawtooth wave. Although DC voltage source 310 and half-bridge inverter circuit 312 are shown in FIG. 3, any circuit configured to generate an AC signal is within the scope of the invention. The capacitance value of capacitor 314 and the inductance values of transmitter coils 316 and 318 determine a resonant frequency for transmitter 300, which is preferably in the range of 100 kHz to 250 kHz. The alternating current passing through transmitter coil 316 and transmitter coil 318 generates magnetic flux that can induce a current in a receiver coil or coils (not shown).

Transmitter 300 further includes shield coils 320 and 322 that operate as an electromagnetic shield by virtue of their high-frequency connection to ground. Shield coil 320 preferably has substantially the same shape, number of turns, and area as transmitter coil 316, and shield coil 322 preferably has the same shape, number of turns, and area as transmitter coil 318. Each of shield coils 320 and 322 can also be formed of wire or traces on a printed circuit board using conductive material such as copper, gold, or any other conductive material known in the art. But the thickness of each of shield coils 320 and 322 can be much less than that of transmitter coils 316 and 318 because shield coils 320 and 322 only carry very small high-frequency currents associated with EMI. Shield coil 320 is preferably placed directly above and flush with transmitter coil 316 and shield coil 322 is preferably placed directly above and flush with transmitter coil 318, but shield coils 320 and 322 may be a short distance, on the order of a couple millimeters, from transmitter coils 316 and 318. One end 332 of shield coil 322 is coupled to ground, and the other end 334 of shield coil 322 is coupled to one end 336 of shield coil 320. The other end 338 of shield coil 320 is coupled to a capacitor 324. Capacitor 324 is coupled between shield coil 320 and ground, and preferably has a small capacitance value less than about 1000 pF to allow only high-frequency current to be diverted to ground by shield coils 320 and 322 while not interfering with the intended wireless transmission of power by transmitter coils 316 and 318. In another embodiment, end 338 of shield coil 320 is not connected, i.e., left floating. In another embodiment, the total capacitance value of less than about 1000 pF can be divided between two capacitors, one capacitor coupled between end 338 of shield coil 320 and ground and the second capacitor coupled between end 332 of shield coil 322 and ground. Shield coil 320 will receive and divert to ground any high-frequency EMI generated by transmitter coil 316 and shield coil 322 will receive and divert to ground any high-frequency EMI generated by transmitter coil 318. Because shield coil 320 and transmitter coil 316 are substantially the same shape, EMI emitted by a turn of transmitter coil 316 will be received by a turn of shield coil 320 through intervening capacitance. Similarly, EMI emitted by a turn of transmitter coil 318 will be received by a turn of shield coil 322 through intervening capacitance. Current flowing through shield coil 320 and shield coil 322 caused by received EMI will produce magnetic flux but only in response to high frequency components of the current. The magnetic flux generated by shield coils 320 and 322 will be at a much higher frequency than the flux generated by transmitter coils 316 and 318, and thus will not noticeably affect the transmission of power from transmitter 300 to a receiver.

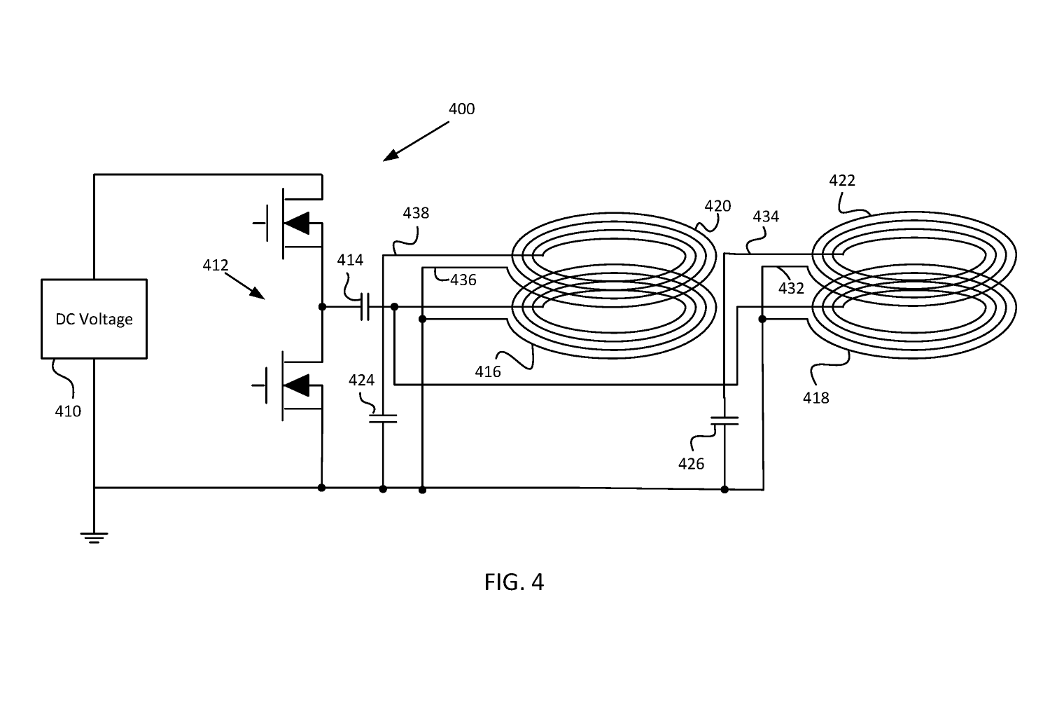

FIG. 4 is a diagram of one embodiment of a wireless power transmitter with multiple electromagnetic interference shields, according to the invention. A transmitter 400 includes, but is not limited to, a DC voltage source 410, a half-bridge inverter circuit 412, a resonant capacitor 414, and transmitter coils 416 and 418. Transmitter coils 416 and 418 are coupled to each other in parallel. Each of transmitter coil 416 and transmitter coil 418 is a flat spiral coil with a predetermined number of turns; however, coils of any shape with any number of turns are within the scope of the invention. Transmitter coils 416 and 418 can be formed of wire or traces on a printed circuit board using conductive material such as copper, gold, or any other conductive material known in the art. Half-bridge inverter circuit 412 is controlled by a control circuit (not shown) to provide an alternating current to capacitor 414 and transmitter coils 416 and 418. The generated AC signal can be, but is not limited to, a square wave, a sinusoidal wave, a triangular wave, or a sawtooth wave. Although DC voltage source 410 and half-bridge inverter circuit 412 are shown in FIG. 4, any circuit configured to generate an AC signal is within the scope of the invention. The capacitance value of capacitor 414 and the inductance values of transmitter coils 416 and 418 determine a resonant frequency for transmitter 400, which is preferably in the range of 100 kHz to 250 kHz. The alternating current passing through transmitter coil 416 and transmitter coil 418 generates magnetic flux that can induce a current in a receiver coil or coils (not shown).

Transmitter 400 further includes shield coils 420 and 422 that operate as an electromagnetic shield by virtue of their high-frequency connection to ground. Shield coil 420 preferably has substantially the same shape, number of turns, and area as transmitter coil 416, and shield coil 422 preferably has the same shape, number of turns, and area as transmitter coil 418. can also be formed of wire or traces on a printed circuit board using conductive material such as copper, gold, or any other conductive material known in the art. But the thickness of each of shield coils 420 and 422 can be much less than that of transmitter coils 416 and 418 because shield coils 420 and 422 only carry very small high-frequency currents associated with EMI. Shield coil 420 is preferably placed directly above and flush with transmitter coil 416 and shield coil 422 is preferably placed directly above and flush with transmitter coil 418, but shield coils 420 and 422 may be a short distance, on the order of a couple millimeters, from transmitter coils 416 and 418. One end 432 of shield coil 422 is coupled to ground, and the other end 434 of shield coil 422 is coupled to a capacitor 426. Capacitor 426 is coupled between shield coil 422 and ground, and preferably has a small capacitance value less than about 1000 pF to allow only high-frequency current to be diverted to ground by shield coil 422 while not interfering with the intended wireless transmission of power by transmitter coil 418. In another embodiment, end 434 of shield coil 422 is not connected, i.e., left floating. In another embodiment, the total capacitance value of less than about 1000 pF can be divided between two capacitors, one capacitor coupled between end 434 of shield coil 422 and ground and the second capacitor coupled between end 432 of shield coil 422 and ground. One end 436 of shield coil 420 is coupled to ground, and the other end 438 is coupled to a capacitor 424. Capacitor 424 is coupled between shield coil 420 and ground, and preferably has a small capacitance value less than about 1000 pF to allow only high-frequency current to be diverted to ground by shield coil 420 while not interfering with the intended wireless transmission of power by transmitter coil 416. In another embodiment, end 438 of shield coil 420 is not connected, i.e., left floating. In another embodiment, the total capacitance value of less than about 1000 pF can be divided between two capacitors, one capacitor coupled between end 436 of shield coil 420 and ground and the second capacitor coupled between end 438 of shield coil 420 and ground. Shield coil 420 will receive and ground high-frequency EMI generated by transmitter coil 416 and shield coil 422 will receive and ground high-frequency EMI generated by transmitter coil 418. Because shield coil 420 and transmitter coil 416 are substantially the same shape, EMI emitted by a turn of transmitter coil 416 will be received by a turn of shield coil 420 through intervening capacitance. Similarly, EMI emitted by a turn of transmitter coil 418 will be received by a turn of shield coil 422 through intervening capacitance. Current flowing through shield coil 420 and shield coil 422 caused by received EMI will produce magnetic flux but only in response to high frequency components of the current. The magnetic flux generated by shield coils 420 and 422 will be at a much higher frequency than the flux generated by transmitter coils 416 and 418, and thus will not noticeably affect the transmission of power from transmitter 400 to a receiver. In another embodiment, a transmitter includes transmitter coils coupled in parallel, like transmitter coils 416 and 418 in FIG. 4, and shield coils coupled in series with a single capacitor coupled between the shield coils and ground, like shield coils 320 and 322 in FIG. 3.

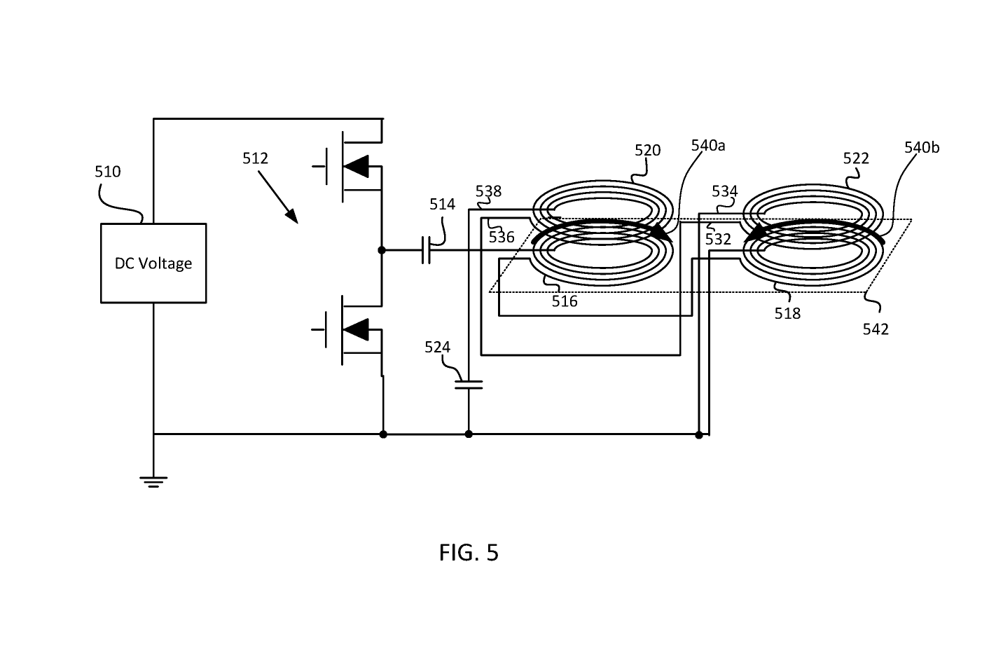

FIG. 5 is a diagram of one embodiment of a wireless power transmitter with an electromagnetic interference shield, according to the invention. A transmitter 500 includes, but is not limited to, a DC voltage source 510, a half-bridge inverter circuit 512, a resonant capacitor 514, and transmitter coils 516 and 518. Transmitter coils 516 and 518 are coupled to each other in series. An optional magnetic layer 542 magnetically couples transmitter coils 516 and 518. Each of transmitter coil 516 and transmitter coil 518 is a flat spiral coil with a predetermined number of turns; however, coils of any shape with any number of turns are within the scope of the invention. Transmitter coils 516 and 518 can be formed of wire or traces on a printed circuit board using conductive material such as copper, gold, or any other conductive material known in the art. Half-bridge inverter circuit 512 is controlled by a control circuit (not shown) to provide an alternating current to capacitor 514 and transmitter coils 516 and 518. The generated AC signal can be, but is not limited to, a square wave, a sinusoidal wave, a triangular wave, or a sawtooth wave. Although DC voltage source 510 and half-bridge inverter circuit 512 are shown in FIG. 5, any circuit configured to generate an AC signal is within the scope of the invention. The capacitance value of capacitor 514 and the inductance values of transmitter coils 516 and 518 determine a resonant frequency for transmitter 500, which is preferably in the range of 100 kHz to 250 kHz.

Transmitter coil 516 is coupled to transmitter coil 518 in such a way that a current 540a flows through transmitter coil 516 in a clockwise direction and a current 540b flows through transmitter coil 518 in a counter-clockwise direction. If transmitter coils 516 and 518 are identical, the flow of current 540a through transmitter coil 516 generates a magnetic field equivalent in magnitude to the magnetic field generated by the flow of current 540b through transmitter coil 518. Because current 540a and current 540b are flowing in opposite directions at any given point in time, the magnetic field generated by current 540a is in a different direction than the magnetic field generated by current 540b (i.e., the magnetic fields have different polarity). The operation and benefits of pairs of coils producing magnetic flux with opposite polarities is further disclosed in co-pending U.S. application Ser. No. ______, entitled “Wireless Power Transfer Using Multiple Coil Arrays,” filed on Mar. 28, 2016, the subject matter of which is incorporated herein by reference. The magnetic flux emitted by transmitter coils 516 and 518 can induce a current in a receiver coil or coils (not shown).

Transmitter 500 further includes shield coils 520 and 522 that operate as an electromagnetic shield by virtue of their high-frequency connection to ground. Shield coil 520 preferably has substantially the same shape, number of turns, and area as transmitter coil 516, and shield coil 522 preferably has the same shape, number of turns, and area as transmitter coil 518. Each of shield coils 520 and 522 can also be formed of wire or traces on a printed circuit board using conductive material such as copper, gold, or any other conductive material known in the art. But the thickness of each of shield coils 520 and 522 can be much less than that of transmitter coils 516 and 518 because shield coils 520 and 522 only carry very small high-frequency currents associated with EMI. Shield coil 520 is preferably placed directly above and flush with transmitter coil 516 and shield coil 522 is preferably placed directly above and flush with transmitter coil 518, but shield coils 520 and 522 may be a short distance, on the order of a couple millimeters, from transmitter coils 516 and 518. Shield coil 520 and shield coil 522 are coupled together in series in such a way that a current flowing through shield coil 520 in a clockwise direction will flow through shield coil 522 in a counter-clockwise direction. One end 534 of shield coil 522 is coupled to ground, and the other end 532 of shield coil 522 is coupled to one end 536 of shield coil 520. The other end 538 of shield coil 520 is coupled to a capacitor 524. Capacitor 524 is coupled between shield coil 520 and ground, and preferably has a small capacitance value less than about 1000 pF to allow only high-frequency current to be diverted to ground by shield coils 520 and 522 while not interfering with the intended wireless transmission of power by transmitter coils 516 and 518. In another embodiment, end 538 of shield coil 520 is not connected, i.e., left floating. In another embodiment, the total capacitance value of less than about 1000 pF can be divided between two capacitors, one capacitor coupled between end 538 of shield coil 520 and ground and the second capacitor coupled between end 534 of shield coil 522 and ground. Shield coil 520 will receive and divert to ground any high-frequency EMI generated by transmitter coil 516 and shield coil 522 will receive and divert to ground any high-frequency EMI generated by transmitter coil 518. Because shield coil 520 and transmitter coil 516 are substantially the same shape, EMI emitted by a turn of transmitter coil 516 will be received by a turn of shield coil 520 through intervening capacitance. Similarly, EMI emitted by a turn of transmitter coil 518 will be received by a turn of shield coil 522 through intervening capacitance. Current flowing through shield coil 520 and shield coil 522 caused by received EMI will produce magnetic flux but only in response to high frequency components of the current. The magnetic flux generated by shield coils 520 and 522 will be at a much higher frequency than the flux generated by transmitter coils 516 and 518, and thus will not noticeably affect the transmission of power from transmitter 500 to a receiver.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A wireless power transmitter comprising:
an alternating current source;
a transmitter coil configured to receive an alternating current from the alternating current source; and
a shield coil located substantially directly above the transmitter coil, one end of the shield coil being coupled to ground.

2. The wireless power transmitter of claim 1, wherein the shield coil has a shape, number of turns, and an area that are substantially the same as a shape, a number of turns, and an area of the transmitter coil.

3. The wireless power transmitter of claim 1, wherein the shield coil is located at a distance less than four millimeters from the transmitter coil.

4. The wireless power transmitter of claim 1, wherein the shield coil is in contact with the transmitter coil.

5. The wireless power transmitter of claim 1, further comprising a capacitor coupled between a second end of the shield coil and ground, the capacitor having a capacitance value less than about 100 pF.

6. The wireless power transmitter of claim 1, wherein the shield coil is coupled to ground through a capacitor, the capacitor having a capacitance value less than about 1000 pF.

7. The wireless power transmitter of claim 1, further comprising
a second transmitter coil coupled in parallel to the transmitter coil; and
a second shield coil located substantially directly above the second transmitter coil, one end of the second shield coil coupled to ground.

8. The wireless power transmitter of claim 7, further comprising a capacitor coupled between a second end of the second shield coil and ground, the capacitor having a capacitance value less than about 1000 pF.

9. The wireless power transmitter of claim 7, wherein the second shield coil is coupled to ground through a capacitor, the capacitor having a capacitance value less than about 1000 pF.

10. A wireless power transmitter comprising:
a transmitter coil configured to emit magnetic flux when an alternating current flows through the transmitter coil;
a shield coil located substantially directly above the transmitter coil, one end of the shield coil being coupled to ground; and
a capacitor coupled between a second end of the shield coil and ground.

11. The wireless power transmitter of claim 10, wherein the shield coil has a shape, number of turns, and an area that are substantially the same as a shape, a number of turns, and an area of the transmitter coil.

12. The wireless power transmitter of claim 10, wherein the shield coil is located at a distance less than four millimeters from the transmitter coil.

13. The wireless power transmitter of claim 10, wherein the capacitor has a capacitance value less than about 1000 pF.

14. The wireless power transmitter of claim 10, further comprising
a second transmitter coil coupled in parallel to the transmitter coil;
a second shield coil located substantially directly above the second transmitter coil, one end of the second shield coil coupled to ground; and
a second capacitor coupled between a second end of the second shield coil and ground.

15. The wireless power transmitter of claim 14, wherein the second capacitor has a capacitance value less than about 1000 pF.

16. A wireless power transmitter comprising:
an alternating current source;
a plurality of transmitter coils configured to receive an alternating current from the alternating current source, the plurality of transmitter coils coupled together in series; and
a plurality of shield coils, each of the plurality of shield coils located substantially directly above one of the plurality of transmitter coils, the plurality of shield coils being coupled together in series between ground and a first end of a capacitor, the capacitor having a second end coupled to ground.

17. The wireless power transmitter of claim 16, wherein each of the plurality of shield coils has a shape, number of turns, and an area that are substantially the same as a shape, a number of turns, and an area of each of the plurality of transmitter coils.

18. The wireless power transmitter of claim 16, wherein each of the plurality of shield coils is located at a distance less than four millimeters from one of the plurality of transmitter coils.

19. The wireless power transmitter of claim 16, wherein the capacitor has a capacitance value less than about 1000 pF.

20. The wireless power transmitter of claim 16, wherein the plurality of transmitter coils are coupled together such that at least one of the plurality of transmitter coils is configured to emit magnetic flux having a first polarity and a second one of the plurality of transmitter coils is configured to emit magnetic flux having a second polarity that is opposite to the first polarity.
